(19) United States
(12) Patent Application Publication
(10) Pub. No.: US 2025/0335699 A1
(43) Pub. Date: Oct. 30, 2025

(54) REWRITING TEXT USING MACHINE-LEARNED LANGUAGE MODELS AND PRESENTING REWRITTEN TEXT ON USER INTERFACE

(71) Applicant: Textio, Inc., Seattle, WA (US)

(72) Inventors: Adam Sanderson, Bainbridge Island, WA (US); Cass Petrus, Seattle, WA (US); Jesse Clay Satterfield, Seattle, WA (US)

(21) Appl. No.: 18/647,970

(22) Filed: Apr. 26, 2024

(51) Int. Cl. G06F 40/166; G06F 3/0484; G06F 21/62; G06F 40/295; G06F 40/40

(52) U.S. Cl. CPC G06F 40/166; G06F 3/0484; G06F 21/6245; G06F 40/295; G06F 40/40

(57) ABSTRACT

A server generates a user interface for allowing a user to rewrite portions of text for an electronic document to mitigate detected issues. For an input document, the server generates one or more indications over the one or more phrases in the sentence. An indication for a phrase may be generated based on a respective category associated with the phrase. Responsive to receiving an indication from the user to rewrite the sentence, the server generates a prompt to a machine-learned language model. The server receives a response generated by executing the machine-learned language model on the prompt. The server generates a pane user element to present the candidate sentence and an evaluation of the candidate sentence to the user, and responsive to receiving a selection of a candidate sentence, replacing the sentence in the editor with the selected sentence on the user interface.

### BACKGROUND

### Field of Disclosure

The present invention generally relates to rewriting texts for an electronic document, and more specifically to an interface for rewriting texts using a large language model (LLM) and mitigating issues in the text.

### Description of the Related Art

Many electronic documents are drafted with the desired objective of providing feedback or inducing responses to the document from certain types of readers. For example, a performance feedback document is written with the objective of evaluating or assessing an employee's performance and providing actionable feedback and objectives for self-improvement. Often times, the text in the electronic document written by an author may contain issues that should be mitigated, e.g., biased language. However, it is difficult for the author to detect these issues or rewrite the text to resolve these issues.

### SUMMARY

The above and other issues are addressed by a method, a computer-readable medium, and a server for generating a user interface (UI) for allowing a user to rewrite portions of text for an electronic document to mitigate detected issues in the text. An embodiment of the method comprises displaying a user interface configured with an editor to allow a user to enter and edit an electronic document. The method comprises of a sentence of the electronic document, detecting issues for mitigation in one or more phrases of the sentence with respect to a set of categories. The method further comprises generating one or more indications over the one or more phrases in the sentence. An indication for a phrase may be generated based on a respective category associated with the phrase.

The method further comprises responsive to receiving an indication from the user to rewrite the sentence, generating a prompt to a machine-learned language model. The prompt may specify at least text of the sentence and a request to generate a set of candidate sentences. The method comprises receiving a response generated by executing the machine-learned language model on the prompt. For a candidate sentence, the method comprises detecting issues for mitigation in the candidate sentence to evaluate whether a degree of the detected issues in the candidate sentence is less than a predetermined threshold. The method further comprises generating a pane user element to present the candidate sentence and an evaluation of the candidate sentence to the user, and responsive to receiving a selection of a candidate sentence, replacing the sentence in the editor with the selected sentence on the user interface.

### BRIEF DESCRIPTION OF THE DRAWINGS

Figure (FIG. 1 is a high-level block diagram illustrating an embodiment of an environment for a UI for rewriting texts using a large language model (LLM) and mitigating issues in the text, according to one embodiment.

FIG. 2 is a high-level block diagram illustrating an example computer for implementing the client device, the analysis server, and/or the posting server of FIG. 1.

FIG. 3 is a high-level block diagram illustrating a detailed view of the document analysis module of the analysis server, according to one embodiment.

FIGS. 4A-4E are example user interface screenshots for rewriting text in an input document, according to one embodiment.

FIG. 5 is a flowchart illustrating a process of rewriting text for an input document, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

FIG. 1 is a high-level block diagram illustrating an environment 100 for optimizing a document to achieve its desired objectives, according to one embodiment. The environment 100 includes a client device 110 connected by a network 122 to an analysis server 126 and a posting server 134. Here only one client device 110, one analysis server 126, and one posting server 134 are illustrated but there may be multiple instances of each of these entities. For example, there may be thousands or millions of client devices 110 in communication with one or more analysis servers 126 or posting servers 134.

The network 122 provides a communication infrastructure between client devices 110, the analysis server 126, and the posting server 134. The network 122 is typically the Internet, but may be any network, including and not limited to a Local Area Network (LAN), a Metropolitan Area Network (MAN), a Wide Area Network (WAN), a mobile wired or wireless network, a private network, or a virtual private network.

The client device 110 is a computing device such as a smartphone with an operating system such as ANDROID® or APPLE® IOS®, a tablet computer, a laptop computer, a desktop computer, or any other type of network-enabled device. A client device 110 may include the hardware and software needed to connect to the network 122 (e.g., via Wi-Fi and/or 4G or other wireless telecommunication standards).

The client device 110 includes a document input module 114 that allows the user of the client device 110 to interact with the analysis server 126 and the posting server 134. The document input module 114 allows the user to input a document as formatted text, and forwards the document to the analysis server 126 or to the posting server 134 for posting to the computer network 122. The document input module 114 also allows the user to perform one or more tasks in conjunction with the analysis server 126 or presents any feedback data from the analysis server 126 or the posting server 134 back to the user of the client device 110. A client device 110 may also be used by a reader of a posted document to respond to the posting.

In one embodiment, the document input module 114 is configured within a browser that allows a user of the client device 110 to interact with the analysis server 126 and the posting server 134 using standard Internet protocols. In another embodiment, the document input module 114 includes a dedicated application specifically designed (e.g., by the organization responsible for the analysis server 126 or the posting server 134) to enable interactions among the client device 110 and the servers. In one embodiment, the document input module 114 includes a user interface 118 that allows the user of the client device 110 to edit and format the document and also presents feedback data about the document from the analysis server 126 or the posting server 134 to the client device 110.

Generally, the content of the document includes text written and formatted by an author directed towards achieving one or more desired objectives when presented to readers. A document may be classified into different types depending on its primary objective. For example, a document may be classified as a performance feedback document when the primary objective is to evaluate or assessing an employee's performance and provide actionable feedback. As another example a document may be classified as a recruiting document when the primary objective of the document is to gather candidates to fill a vacant job position at a business organization. As another example, the document may be classified as a campaign speech when the primary objective of the document is to relay a political message of a candidate running for government office to gather a high number of votes for an election.

The analysis server 126 includes a document analysis module 130 that displays a user interface (UI) 118 on the client device 110 configured with a document editor to allow a user to enter and edit an electronic document. In one embodiment, the document analysis module 130 evaluates text in an input document for issues such as bias and allows a user to request rewriting of the text depending on the objective of the document. In one embodiment, the issues for mitigation are generally to improve effectiveness of the writing for the specific purpose of the electronic document. As an example, the set of features may also detect humor or language with legal risk in a performance feedback document that would be inappropriate for that type of document. However, it is appreciated that in some other embodiments, the issues for mitigation include other categories of issues that improve the effectiveness of the electronic document. The document analysis module 130 obtains candidate replacement texts in conjunction with a large language model (LLM) hosted by the model serving system 145. The document analysis module 130 evaluates candidate texts for issues (e.g., bias) and indicate whether the candidate text is verified by the analysis server 126. The user can select a candidate replacement text to replace the sentence in the editor.

Specifically, the document analysis module 130 receives an electronic document via the editor in the interface 118 of a client device 110. For each sentence in the document, the document analysis module 130 detects issues for mitigation in the sentence with respect to a set of categories. The document analysis module 130 generates one or more indications over one or more phrases in the sentence. In one embodiment, an indication generated for a phrase is based on the detection of a respective category of bias associated with the phrase. In one embodiment, a phrase may be a set of one or more words in the sentence. For example, a phrase may be a single word, a phrase of three contiguous words, or even a sub-phrase of two words in one portion of the sentence and another sub-phrase of three words in another portion of the sentence.

Responsive to receiving an indication from a user to generate replacement texts, the document analysis module 130 generates a prompt to a machine-learned language model (deployed on the model serving system 145). In one embodiment, the prompt specifies at least the text of the sentence and a request to generate a set of candidate replacement texts. The document analysis module 130 receives, from the machine-learned language model, a response generated by executing the machine-learned language model on the prompt.

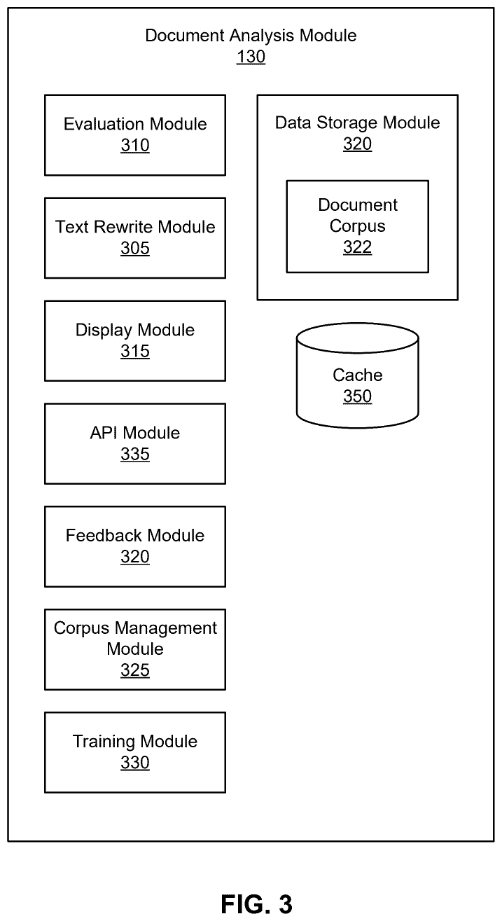

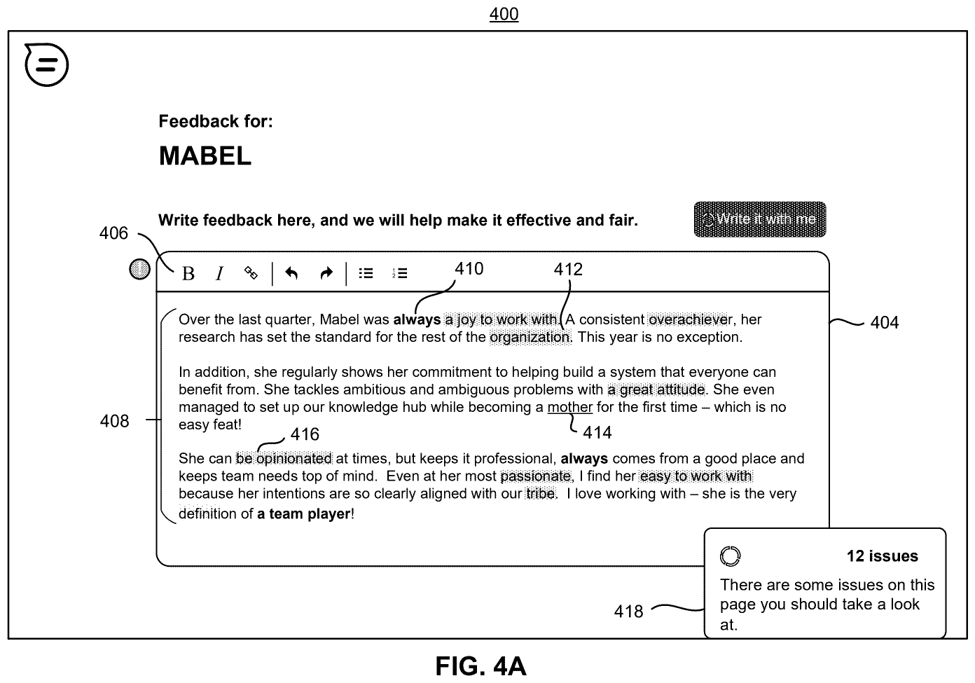

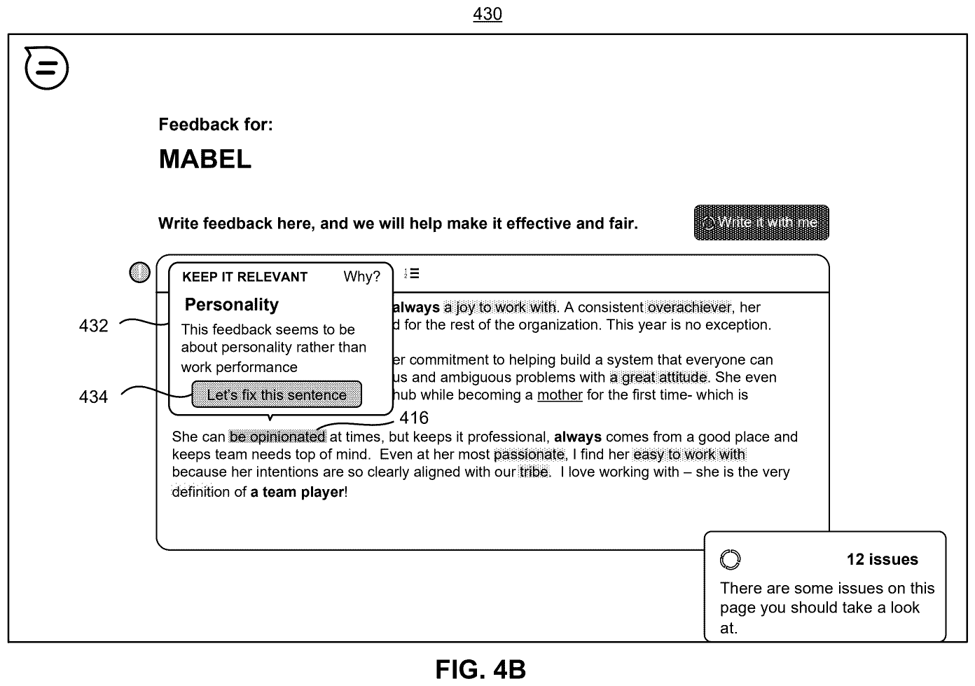

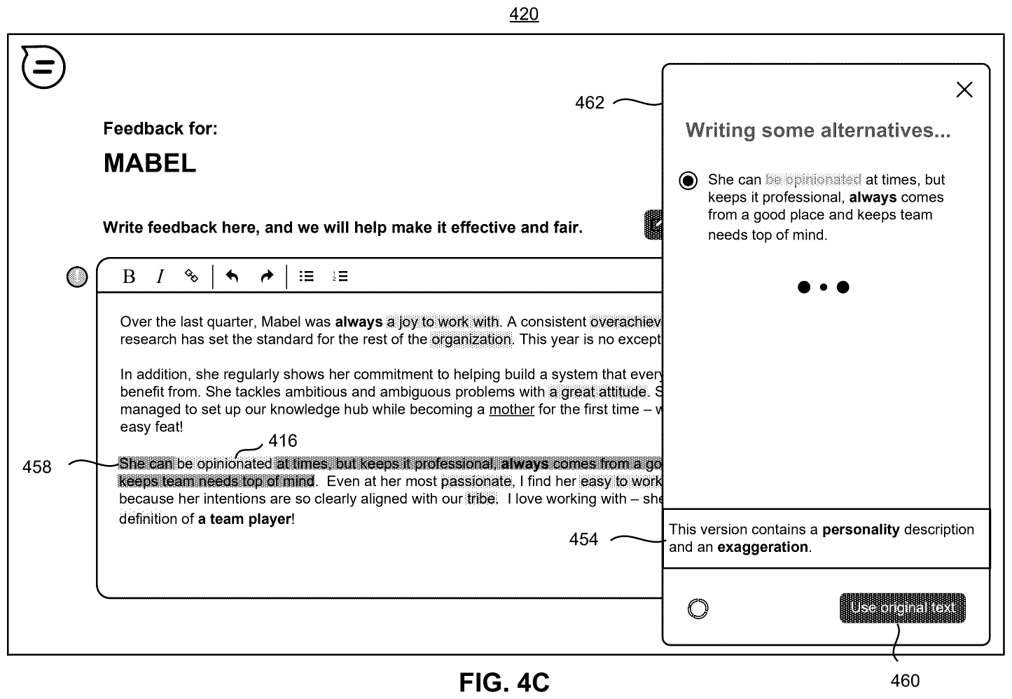

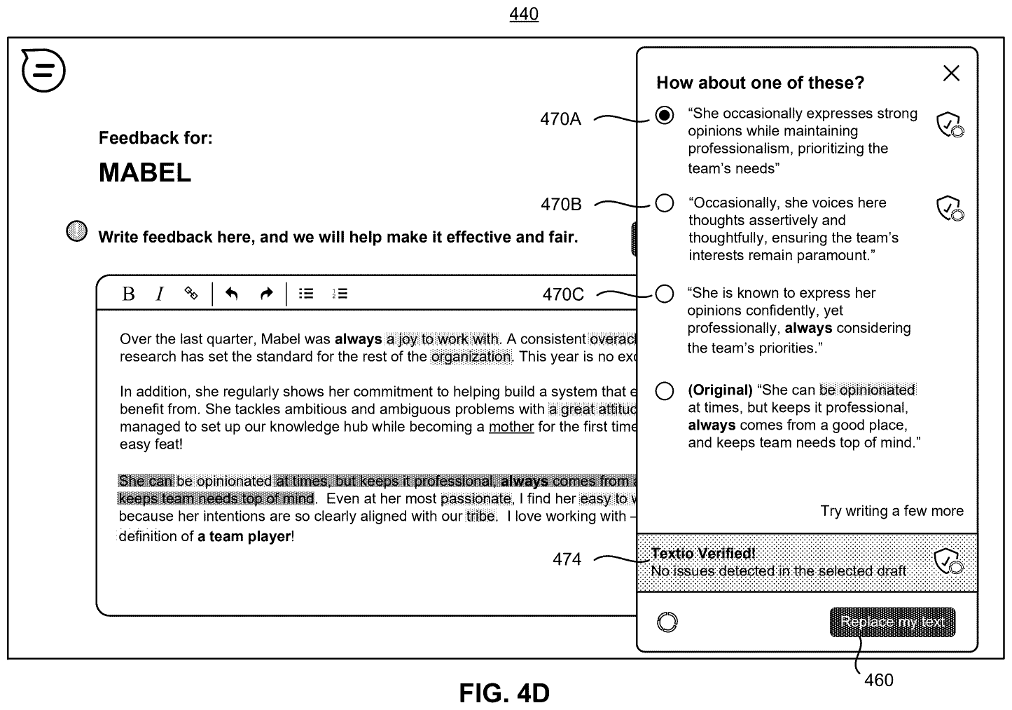

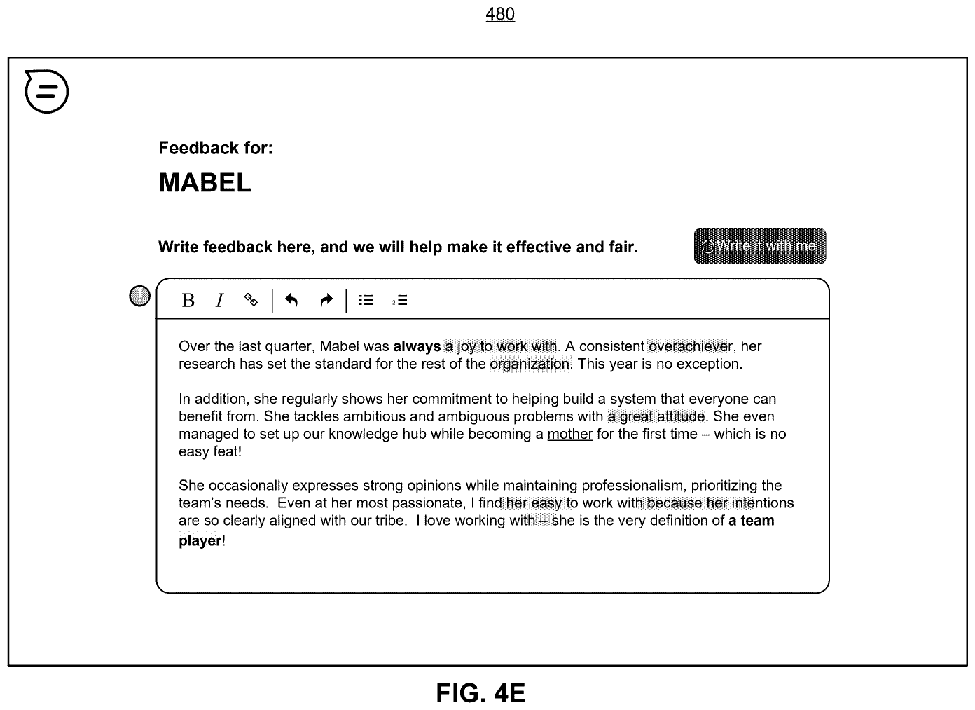

For each candidate replacement text, the document analysis module 130 detects issues for mitigation or improvement in the candidate replacement text by applying a set of defined features to evaluate whether a degree of the detected issues in the candidate replacement text is less than a predetermined threshold. In one embodiment, the issues for mitigation are whether the text includes biased language with respect to one or more different categories. The document analysis module 130 generates an element (e.g., side pane element) on the interface to present the candidate replacement texts and the evaluation of the candidate replacement texts to the user. Responsive to receiving a selection of a candidate text from the user, the document analysis module 130 replaces the sentence in the document editor with the selected candidate replacement text. A more detailed description of this process is described below in conjunction with FIGS. 3 and 4A-4E.

In one embodiment, the document analysis module 130 further configures an application programming interface (API) server (e.g., on-premise server or cloud-based system) that allows the online system 140 to build, manage, and deploy API's (e.g., REST API's or RPC's). The API server is configured with one or more resources (e.g., databases) that are exposed to users via methods (e.g., standardized or non-standardized). The API receives requests from users (e.g., users of client devices 110), performs one or more requested operations, and returns a response to the request to the client device 110. The request received from the user may be associated with attributes that parameterize the operations. The resources of the API server are endpoints with a respective URI for accessing the resource.

In one embodiment, the API receives input text in a request. The input text may correspond to a document, a paragraph, and the like. The API provides as a response, output text that is a version of the input text that has replaced harmful, biased language with language that achieves a desired objective (e.g., language that is safe for the work) in conjunction with the functionalities of the modules in the document analysis module 130. The API may communicate with client devices 110 through standard schema (e.g., REST or RESTful schema) in markup language such as JSON or XML. A more detailed description of the API is provided below in conjunction with FIG. 3.

The posting server 134 includes a document posting module 138 that posts the optimized document and receives outcome data on the optimized document. For example, the document posting module 138 may post a recruiting document optimized based on the evaluations received by the document analysis module 130. After the document has been posted, the document posting module 138 may receive applications for the posted position, as well as outcome data describing characteristics of people who responded to the document. The collected outcome data may be provided to the document analysis module 130 in order to refine evaluations on other documents, and also may be provided back to the client device 110.

The model serving system 145 deploys one or more machine-learned models. The model serving system 145 receives requests from the analysis server 126 to perform inference tasks using machine-learned models. The inference tasks include, but are not limited to, natural language processing (NLP) tasks, audio processing tasks, image processing tasks, video processing tasks, and the like. In one embodiment, the machine-learned models deployed by the model serving system 145 are models configured to perform one or more NLP tasks. The NLP tasks include, but are not limited to, text generation, query processing, machine translation, chatbot applications, and the like. In one embodiment, the language model is configured as a transformer neural network architecture. Specifically, the transformer model is coupled to receive sequential data tokenized into a sequence of input tokens and generates a sequence of output tokens depending on the inference task to be performed.

Specifically, the model serving system 145 receives a request including input data (e.g., text data, audio data, image data, or video data) and encodes the input data into a set of input tokens. The model serving system 145 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

The sequence of input tokens or output tokens are arranged as a tensor with one or more dimensions, for example, one dimension, two dimensions, or three dimensions. For example, one dimension of the tensor may represent the number of tokens (e.g., the length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the machine-learned models are large language models (LLMs) trained on a large corpus of training data to generate outputs for NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 10 billion, at least 100 billion, at least 1 trillion, at least 1.5 trillion parameters, and the like.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM is trained by the analysis server 126 or entities/systems different from the analysis server 126. An LLM may be trained on a large amount of data from various data sources.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations. The LLM is configured to receive a prompt and generate a response to the prompt. The prompt may include a task request and contextual information that is useful for responding to the prompt. The LLM infers the response to the prompt from the knowledge that the LLM was trained on and/or from the contextual information included in the prompt.

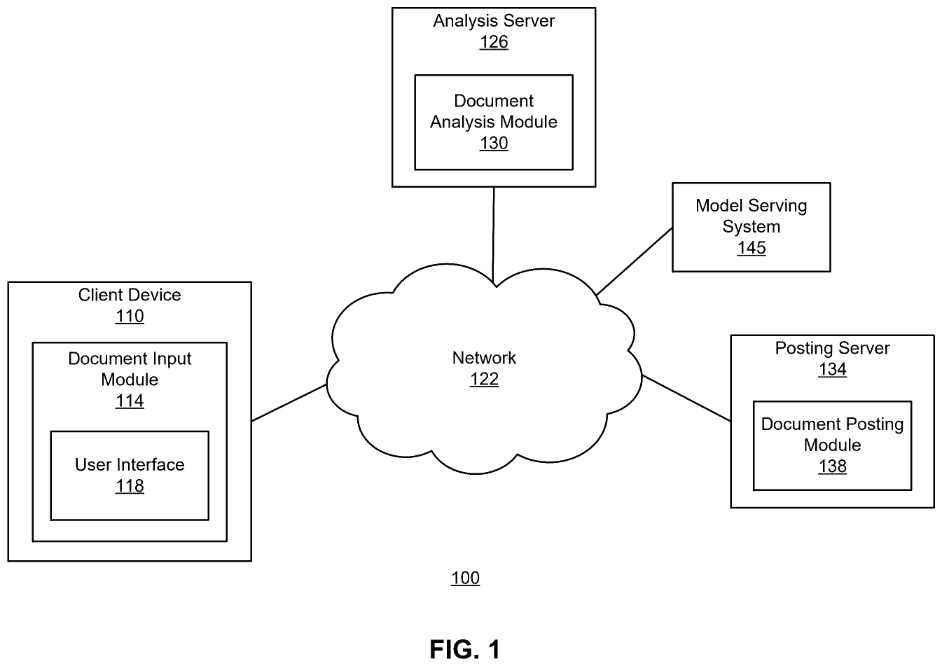

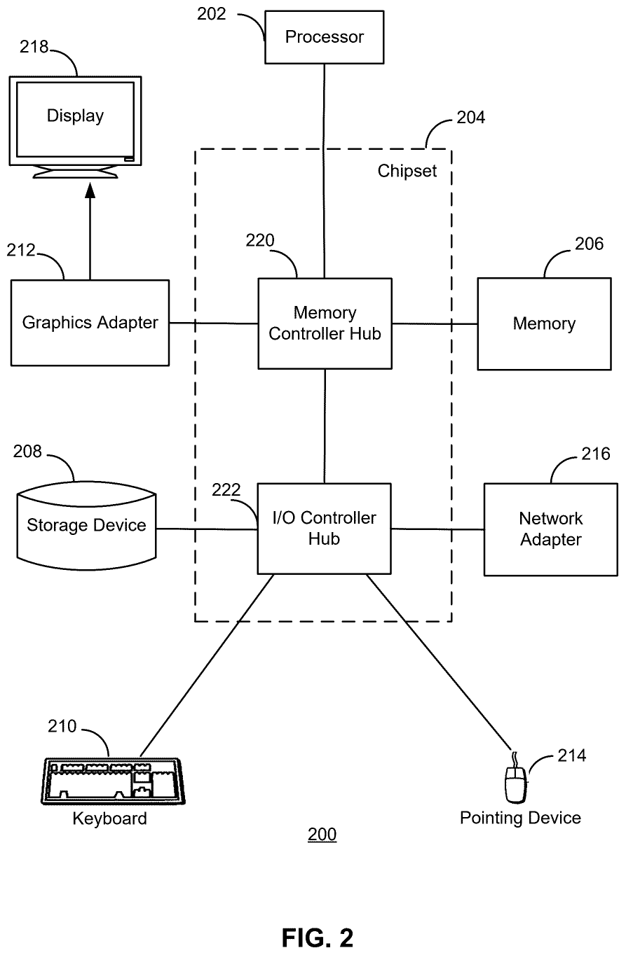

FIG. 2 is a high-level block diagram illustrating an example computer 200 for implementing the client device 110, the analysis server 126, model serving system 145, and/or the posting server 134 of FIG. 1. The computer 200 includes at least one processor 202 coupled to a chipset 204. The chipset 204 includes a memory controller hub 220 and an input/output (I/O) controller hub 222. A memory 206 and a graphics adapter 212 are coupled to memory controller hub 220, and a display 218 is coupled to the graphics adapter 212. A storage device 208, an input device 214, and network adapter 216 are coupled to the I/O controller hub 222. Other embodiments of the computer 200 have different architectures.

The storage device 208 is a non-transitory computer-readable storage medium such as a hard drive, compact disk read-only memory (CD-ROM), DVD, or a solid-state memory device. The memory 206 holds instructions and data used by the processor 202. The input interface 214 is a touch-screen interface, a mouse, track ball, or other type of pointing device, a keyboard, or some combination thereof, and is used to input data into the computer 200. The graphics adapter 212 displays images and other information on the display 218. The network adapter 216 couples the computer 200 to one or more computer networks.

The computer 200 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 208, loaded into the memory 206, and executed by the processor 202. The types of computers 200 used by the entities of FIG. 1 can vary depending upon the embodiment and the processing power required by the entity. The computers 200 can lack some of the components described above, such as graphics adapters 212, and displays 218. For example, the analysis server 126 can be formed of multiple blade servers communicating through a network such as in a server farm.

FIG. 3 is a high-level block diagram illustrating a detailed view of the document analysis module 130 of the analysis server 126, according to one or more embodiments. The document analysis module 130 comprises of modules including a data storage module 320, an evaluation module 310, a text rewrite module 305, a display module 315, an API module 335, a feedback module 320, a corpus management module 325, and a training module 330. Some embodiments of the document analysis module 130 have different modules than those described here. Similarly, the functions can be distributed among the modules in a different manner than is described here.

The evaluation module 310 evaluates text to generate an evaluation on whether the text has one or more issues that need mitigation or improvement with respect to the objective of the electronic document. In one embodiment, the issues for mitigation are whether the text includes bias. In one embodiment, the evaluation module 310 applies a set of features to each sentence of the text that detects the presence of a set of categories of bias in the sentence. In one embodiment, the features include features for detecting offensive language, harmful or potentially harmful language, insults, long sentences, long paragraphs, cliches, discriminatory language, exaggerations, fixed mindset languages, jargons, and language characterizing personality. In one embodiment, the evaluation module 310 assigns an impact score to each category when the feature for the category recognizes bias for that category.

In one embodiment, features that are generated via a rule-based process may include three or more categories of rules including at least exclusionary phrasing that should not be highlighted in the text, matching against different linguistic surface forms of the word, and matching against parts of speech. In one embodiment,
the feature for detecting offensive language is a rule-based process that applies one or more rules to detect presence of offensive language in the text and has a high impact score (e.g., 50 points); in one embodiment, the process applies the three or more rules to detect presence of offensive language,
the feature for detecting harmful or potentially harmful language is a rule-based process that applies one or more rules to detect presence of harmful or potentially harmful language in the text and has a moderate impact score (e.g., 20 points); in one embodiment, the process applies the three or more rules to detect presence of harmful or potentially harmful language,
the feature for detecting insults is a machine-learned model based process that applies a supervised, machine-learned model (e.g., via API call) to detect presence of insults in the text and has a high impact score (e.g., 50 points),
the feature for detecting long sentences is a rule-based process that applies one or more rules to detect presence of long sentences in the text and has a low impact score (e.g., 4 points),
the feature for detecting long paragraphs is a rule-based process that applies one or more rules to detect presence of long paragraphs in the text and has a low impact score (e.g., 4 points),
the feature for detecting cliches is a rule-based process that applies one or more rules to detect presence of cliches in the text and has a low impact score (e.g., 4 points); in one embodiment, the process applies the three or more rules to detect presence of clichés in the text,
the feature for detecting discriminatory language is a supervised, machine-learned model (e.g., via API call) in conjunction with 3 or more rules to detect presence of discriminatory language in the text and has a high impact score (e.g., 50 points),
the feature for detecting exaggerations is a rule-based process that applies one or more linguistic rules to detect presence of exaggerations in the text and has a low impact score (e.g., 4 points); in one embodiment, the process applies the three or more rules to detect presence of exaggeration in the text,
the feature for detecting fixed mindset languages is a rule-based process that applies one or more linguistic rules to detect presence of fixed mindset languages in the text and has a low impact score (e.g., 4 points); in one embodiment, the process applies the three or more rules to detect presence of fixed mindset languages,
the feature for detecting jargons is a rule-based process that applies one or more linguistic rules to detect jargon in the text and has a low impact score (e.g., 4 points); in one embodiment, the process applies the three or more rules to detect presence of jargons, and
the feature for detecting language characterizing personality is a machine-learned model based process that applies a machine-learned model (e.g., via API call) in conjunction with three or more rules to detect the presence of language characterizing personality in the text and has a low impact score (e.g., 4 points).

As an example, for the example text:
“This will ensure that everyone is on the same page and prevent any potential misunderstandings. [Sentence 1] Additionally, consider diversifying your communication methods to cater to different preferences and situations. [Sentence 2] Overall, your strong communication skills contribute to a productive work environment. [Sentence 3]”,
the evaluation module 310 may apply the set of features and determine that the phrase “is on the same page” is a cliché via multiple rules that match against a dictionary of known cliches. The rules will highlight and flag any variations of cliches in the text.

Thus, as a user is editing an electronic document in the editor of the user interface 118, the evaluation module 310 may continuously receive the text of the document, parse the document into sentences, and generate an evaluation for each sentence that indicates detected categories of bias in one or more phrases in the sentence. In one embodiment, a phrase is a unit of one or more words. The evaluation module 310 provides evaluations of the sentences in the electronic document to the display module 315 such that indications for the detected phrases are presented on the user interface 118. As the user is revising and modifying the document, the evaluation module 310 receives the document such that results of the evaluation can be continuously updated real-time in the background. An example UI is described below in more detail in conjunction with FIG. 4A.

In one embodiment, the text for evaluation is associated with a domain. For example, a domain may correspond to general text, a performance feedback document, or a job post document. The domain may be specified for an API request to rewrite a document, as further described below. In one instance, text associated with a general text domain express bias when the features for detecting offensive language, harmful or potentially harmful language, insults, long sentences, or cliches indicate the presence of these categories of bias, and only these features may contribute to the evaluation. In one instance, text associated with the performance feedback domain express bias when the features for detecting any or all of the features outlined above indicate presence of these categories of bias. In one instance, text associated with the job posting domain express bias when the features for detecting offensive language, harmful or potentially harmful language, insults, long sentences, cliches, fixed mindset languages, or jargon indicate presence of these categories of bias.

In one embodiment, the analysis server 126 configures a cache 350 data store that stores the results of bias detection for each sentence in the input document for the user. For example, the evaluation module 310 may store in the cache 350 that Sentence 1 has a cliché for the phrase “is on the same page,” Sentence 2 has no issue, and Sentence 3 has no issue. When the user further revises the input document to modify an existing sentence or add a new sentence, the evaluation module 310 does not require re-processing of sentences that remain unchanged after the edit. For example, when the user modifies Sentence 2 in the example above, the evaluation module 310 only processes the modified version of Sentence 2 by applying the set of features to the modified sentence to detect the word “always” is a fixed mindset issue.
“This will ensure that everyone is on the same page and prevent any potential misunderstandings. [Sentence 1] Additionally, consider diversifying your communication methods to always cater to different preferences and situations. [Modified Sentence 2] Overall, your strong communication skills contribute to a productive work environment. [Sentence 3]”

In one embodiment, the cache 350 is an in-memory cache that resides in memory, which enables low latency and high throughput data access. In another embodiment, the cache 350 is a persistent data store in cloud storage or disk. The in-memory cache 350 may also be configured as a key-value data store, in which data is fetched using a unique key or a number of unique keys to retrieve the associated value with each key. In one instance, a key is a hash of each sentence (e.g., generated by applying SHA-256 function to the text of the sentence) and the value describes the detected issues in the sentence of the electronic document. In particular, users of the analysis server 126 may continuously update the input document. If the evaluation module 310 were to process each sentence using the set of features each time the input document was changed, the computational latency would increase. For example, rule-based features may have to apply complex rules to each sentence of the document and machine-learned model based features may have to invoke multiple API calls for different machine-learned models to determine the presence of certain issues. By storing the data in the cache 350, the sentences that already have been evaluated and processed by the evaluation module 310 do not need to be re-processed, saving computational resources and improving latency.

In one embodiment, the evaluation module 310 also receives one or more candidate replacement texts for a sentence in the electronic document that is detected to have biased language. The candidate replacement texts are determined to be potential replacement texts for the biased sentence, as described in further detail below in conjunction with the text rewrite module 305. The evaluation module 310 also generates evaluations for the candidate replacement texts by applying on the set of features described above. In one embodiment, for each candidate text for the sentence, the evaluation module 310 detects one or more phrases in the sentence that express bias with respect to one or more categories.

In one embodiment, the evaluation module 310 generates an evaluation score for the candidate replacement text by combining the impact scores for each detected category of bias. The evaluation module 310 may also provide a verification to a respective candidate text if the total evaluation score for the text is below a predetermined threshold (e.g., 0 points or less). For each candidate replacement text, the evaluation module 310 provides the evaluation, including the evaluation score and any verification to the text rewrite module 305, such that the text rewrite module 305 can provide the results for display. However, it is appreciated that in other embodiments, the impact scores and evaluation scores may be deemed relatively less unbiased if the values are higher.

The text rewrite module 305 receives an indication from the user to generate replacement text for a text unit (e.g., a sentence) in the electronic document and obtains candidate replacement texts for the sentence in conjunction with the model serving system 145. The sentence in the document may have one or more detected categories of bias. In one embodiment, the indication is received responsive to the user clicking on an element generated on the user interface 118. An example screenshot is described below in more detail in conjunction with FIG. 4B.

The text rewrite module 305 generates a prompt to a machine-learned language model (e.g., LLM) hosted on the model serving system 145. In one embodiment, the text rewrite module 305 creates the prompt to rewrite a sentence without changing the tense, tone, structure, and point of view of the original sentence, and to replace biased phrases from the sentence with instructions specific to the detected category of bias for that phrase. As an example, a sentence in an input document may be:
“She can be opinionated at times, but keeps it professional, always comes from a good place and keeps team needs top of mind.”
that includes a first detected phrase “be opinionated” that is language characterizing personality, and a second detected phrase “always” that is an exaggeration bias category.

The text rewrite module 305 generates a prompt including a set of components. The first component is the preamble that describes the task. The preamble may differ depending on the desired objective of a document. For example, the preamble may differ for each supported domain, such as general text (“[y]ou are a DEIB coach helping me write bias-free writing for an organization.”), job posting (“[y]ou are a recruiter helping me write bias-free job posting.”), or performance feedback (“[y]ou are a manager helping me write bias-free performance feedback for an employee.”). For example, the prompt may include:
“[y]ou are a manager helping me write actionable performance feedback for a coworker or employee named Mabel Smith who is a female engineer and can be contacted at mabel@fakeemail.com, her manager is Barry Berry who can be contacted at barry@fakeemail.com.”
   The second component may be common and/or consistency instructions. For example, the prompt may further include:
“Be concise and direct. Use fluent and clear language. Exactly match the tone, structure, tense, and point of view. Make as few changes as possible.”
   The third component may be instructions specific to the detected categories of bias in the sentence. For example, the prompt may further include:
“Brainstorm 3 behaviors a person described as opinionated might do in a work context.”
   As another example, when the input sentence is:
“As an engineer of a [racial group], you write clean code.”
   and discriminatory language is detected, the instructions in the prompt may indicate:
“Remove references to the employee's race, they are not relevant.”
   As yet another example, when the input sentence is:
“You should really get better at your job.”
   and insult language is detected, the instructions in the prompt may indicate:
“Use a constructive, measured tone for criticisms.”

The text rewrite module 305 provides the prompt to model serving system 145 for execution. In one embodiment, the text rewrite module 305 invokes an application programming interface (API) call to the model serving system 145 and provides the prompt as the parameters in the API call. In one instance, the API call is configured as a REST API protocol, a RPC call, or a gRPC call. The text rewrite module 305 receives a response to the prompt based on the execution of the prompt with a machine-learned model (e.g., using one or more GPU devices). In one embodiment, the response includes candidate replacement texts for the sentence that were generated based on the prompt.

The text rewrite module 305 provides the candidate texts to the evaluation module 310 for evaluation. As described above, the evaluation for a candidate text includes at least detected categories of bias in the candidate text and an evaluation score that indicates the degree of issues in the candidate text, more specifically, a degree of biased language detected in the candidate text. In addition to the scores, the evaluation for the candidate starter text may include a verification that the score is below a predetermined threshold, indicating that the text has minimal biased language. The text rewrite module 305 provides the evaluated candidate replacement texts to the display module 315 for display, such that the user can select a candidate replacement text to replace the sentence in the editor of the user interface 118. An example UI is described below in more detail in conjunction with FIGS. 4C-4D.

In one embodiment, the text rewrite module 305 further performs a masking process to mask personal identifiable information (PII) in the prompt in the case a user writes PII into the unstructured text before the prompt is provided to the model serving system 145. In one embodiment, the text rewrite module 305 applies a named entity recognition (NER) model or software to the created prompt to detect entities such as person names, telephone numbers, addresses, and the like. For example, the preamble of the example prompt above includes names “Mabel Smith” and “Barry Berry,” as well as email addresses “mabel@fakeemail.com” and “barry@fakeemail.com.”

Depending on the recognized entity, the text rewrite module 305 identifies PII's by identifying recognized entities that are unique strings. The text rewrite module 305 generates numbered placeholder entities and stores the PII unique strings with their corresponding placeholders as key-value pairs (e.g., stored in the cache 350). For example, the text rewrite module 305 may map “Mabel Smith” to placeholder entity PERSON_1 and “Barry Berry” to placeholder entity PERSON_2, and map email “mabel@fakeemail.com” to placeholder entity EMAIL_1 and email “barry@fakeemail.com” to placeholder entity EMAIL_2. Thus, the revised example prompt may be given as:
“[y]ou are writing actionable feedback for a coworker or employee named {PERSON_1} who is a female engineer and can be contacted at {EMAIL_1}, her manager is {PERSON_2} who can be contacted at {EMAIL_2}.
Rewrite this sentence: ‘[s]he can be opinionated at times, but keeps it professional, always comes from a good place and keeps team needs top of mind.’
Be concise and direct. Use fluent and clear language. Exactly match the tone, structure, tense, and point of view. Make as few changes as possible.
Brainstorm 3 behaviors a person described as opinionated might do in a work context.”

The text rewrite module 305 submits the masked prompt to the model serving system 145. After execution, the text rewrite module 305 receives candidate texts generated by the model serving system 145 and performs a de-masking process by retrieving each placeholder entity in the key-value store with the corresponding unique string and replacing the placeholder entity with the retrieved string. The de-masked outputs can be then presented to the user.

In some instances, the model serving system 145 may be managed by the entity responsible for the analysis server 126 or a different entity. When the model serving system 145 is managed by another entity, providing prompts with PII may expose sensitive information, therefore, the masking process allows the analysis server 126 to scrub the PII before sending the prompt to the model serving system 145. Moreover, the model is executed on a computer machine and parameters of the machine-learned model may initially be trained on training data that includes various sources of bias (e.g., webpages, articles, messages, and the like). PII may expose bias such as gender bias, geographical bias, socioeconomic bias, and so on that the model has learned from the training data. Thus, by replacing PII's with placeholder entities, the text generation module 305 can obtain relatively unbiased outputs from a pretrained model.

In one embodiment, when a request to rewrite input text is received via an API request, the text rewrite module 305 may receive multiple sentences from the API module 335. In one embodiment, the text rewrite module 305 identifies each sentence in the input text, generates a dedicated prompt for the sentence based on the detected categories of bias in the sentence, and obtains one or more candidate replacement texts for the sentence (e.g., via one or more API calls to the model serving system 145). The text rewrite module 305 provides the candidate replacement texts for each sentence to the API module 335.

In another embodiment, the text rewrite module 305 uses an asynchronous I/O framework, such as the asyncio framework in Python) to invoke multiple API calls for the multiple sentences of the input text. The asynchronous I/O enables non-blocking I/O operations to perform tasks concurrently without waiting for slow operations like network requests or file I/O to be completed. The text rewrite module 305 invokes API calls to the model serving system 145 with each sentence to be rewritten and the prompt for the sentence using the asynchronous I/O framework. Typically, making multiple API calls for each sentence may trigger a significant amount of latency and delay. By using the asynchronous I/O framework, the candidate replacement texts for multiple sentences can be obtained concurrently, improving latency and network wait time.

The display module 315 generates a UI displayed on the client device 110. The UI includes a document editor that allows a user to input text, and revise and edit the document through the user interface 118 to improve its likelihood of achieving its set of objectives. In one embodiment, the display module 315 generates or renders a component on the UI that when interacted with by the user, triggers the process of generating replacement texts for a sentence (or any other text unit) in the input document.

FIG. 4A is an example user interface 400 for displaying a UI for creating and editing an electronic document, in accordance with an embodiment. The UI may correspond to the user interface 118 generated by the display module 315 on the client device 110. For example, the display module 315 may send code to an application (e.g., browser application or local application) that when rendered displays the interface 400 of FIG. 4A. As shown in FIG. 4A, the UI includes a document editor 404 as a text box for the user to enter and revise an electronic document. The UI also includes a toolbox 406 allowing the user to select different styles for the text or different functionalities when editing the document.

As described above with respect to the evaluation module 310, the contents of the electronic document in the document editor are provided to the evaluation module 310 for evaluation. For each sentence (or any other appropriate text unit), the evaluation includes one or more phrases in the sentence with detected categories of bias. The display module 315 generates indications over the detected phrases to highlight or flag these issues to the user. In one embodiment, the indications are generated using different color per category of bias detected, different patterns per category of bias detected, and the like. As an example, “always” 410 is highlighted with a bolded, “organization” 412 is shaded with a first pattern, “mother” is underlined, and “opinionated” 416 is shaded with a second pattern to annotate the different categories of bias.

Responsive to the user interacting with an annotation, the display module 315 generates one or more elements on the user interface 118 that describe the detected issues and a button allowing the user to request rewriting of the sentence. In one embodiment, responsive to the user hovering over an indication for a detected phrase, the display module 315 generates a popup element including the category of bias detected in the phrase, a detailed description for the category, and the button when clicked, allowing the user to request rewriting of the sentence.

FIG. 4B is an example user interface 430 for displaying a UI for generating a popup element for a detected phrase, in accordance with an embodiment. Specifically, the input document includes a sentence “[s]he can be opinionated at times, but keeps it professional, always comes from a good place and keeps team needs top of mind,” that includes one indication 416 for detecting language characterizing personality, and another indication for detecting fixed mindset language. Responsive to the user hovering over the indication 416 that is an annotation or highlight over the phrase “be opinionated”), the display module 315 generates a popup element 432 describing the detected category. In the example of FIG. 4B, the popup element 432 indicates that a category of “Personality” (i.e., language characterizing personality instead of feedback on work) was detected for the phrase, and describes the reason for the detected category.

Moreover, the display module 315 also generates a button 434 within the popup element labeled “Let's fix this sentence.” Responsive to the user clicking on the button 434, the display module 315 provides the text of the sentence containing the phrase to the text rewrite module 305. As described in detail above in conjunction with the text rewrite module 305, in this manner, the text rewrite module 305 receives the phrases in the sentence that are detected to have biased language, and generates a prompt for the sentence to generate a set of candidate replacement texts. As shown in FIG. 4C, the display module 315 generates a pane element 462 that displays the original sentence in the input document and indicating that candidate replacement texts are being generated for the user.

After the set of candidate replacement texts are generated and evaluated by the evaluation module 310, the display module 315 receives the candidate replacement texts and the evaluations. The display module 315 displays the candidate replacement texts and any detected categories of bias based from the evaluations as well as whether the candidate text is verified. Moreover, the display module 315 configures one or more selection control elements each corresponding to a candidate replacement text that the user can use to select a candidate text for replacement. Responsive to a selection and a request from the user, the display module 315 replaces the original sentence with the selected candidate text on the user interface.

FIG. 4D is an example user interface 440 for displaying a set of candidate replacement texts for an input document, in accordance with an embodiment. As shown in FIG. 4D, the display module 315 receives a set of three candidate replacement texts for the original sentence and the evaluations. The first candidate text does not contain detected issues and is also verified as the evaluation score for the text is zero points (as shown by the displayed icon on the right side of the text). The second candidate text does not contain detected issues and is verified. The third candidate text contains one issue for the phrase “always” that is bolded to flag the issue for the user. The third candidate text is not verified. The fourth text is the text of the original sentence in the document.

As shown in FIG. 4D, the display module 315 presents the candidate replacement texts with one or more selection controls 470A, 470B, 470C, 470D which are radio button elements. The user may select a first candidate replacement text. The display module 315 also configures a button 460 labeled “Replace my text” that when clicked by the user, allows the user to request the original sentence in the electronic document be replaced with the selected text. As shown in FIG. 4E, responsive to the user clicking on the button 460, the sentence is replaced with the candidate replacement text selected by the user. In this manner, the document analysis module 130 receives via a user interface 118 a user selection to arrange sentences in an electronic document based on the degree of bias detected in the sentence, which is a technical improvement over prior user interfaces for text. In one embodiment, the display module 315 identifies the text range associated with the original sentence using natural language processing (NLP) statistical tools. Then the text range is translated into a DOM text range that is stored during the rewriting process. When the user selects a replacement text, the text range is deleted and then the new selected text is inserted.

The user may continue to revise or edit the input document. The evaluation module 310 may hash each sentence and store the results of bias detection in the cache 350, as described in conjunction with the evaluation module 310. For example, the user may add a sentence to the second paragraph. The evaluation module 310 may retrieve the evaluations for sentences remaining the same from the in-memory cache 350 without separately processing the sentences again, and only process the additional new sentence. The display module 315 may additionally present any detected issues in the new sentence in addition to the existing detections. In this way, the latency of obtaining evaluations can be improved even when the electronic document is being frequently edited.

The API module 335 configures an API server (e.g., on-premise or cloud-based system) and builds, manages, and deploys API's (e.g., REST API's). In one embodiment, rather than receiving an indication from a user to rewrite an individual sentence in the user interface 118, the API is configured to receive an input text of one or more sentences and return a revised version of the input text that is rewritten to remove detected bias in the input text. Thus, the entire document as input text is parsed into individual sentences, evaluated, and sentences detected to have bias are rewritten to generate a revised version. The API returns the revised version of the text as the response.

The API is configured to receive requests (e.g., in JSON schema) having a set of attributes. In one embodiment, the API request follows REST schema, and is a POST request. The POST request includes attributes of content and document type. The content attribute includes content of the input text and may be a data type of string. The document type attribute indicates a domain of the input text. For example, the document type may specify that the input text is one of general text, a job post document, or a performance feedback document. As an example, a user may send a request by:

```
POST /v1/content/debias
{
  “content”: “Your attitude and tendency to shift blame onto others
only exacerbates the situation. It is crucial to approach conflicts
with a more open and understanding mindset, focusing on finding a
resolution rather than placing blame. Your offensive and defensive
behavior during conflict resolution creates a hostile environment and
it's worst to work with.”,
  “document_type”: “performance_feedback”,
  “override_english_detection: false
}
```

The API module 335 parses the input text into individual sentences and sends the texts to the evaluation module 310. The API module 335 receives the evaluations from the evaluation module 310, including any detected categories of bias in each sentence. For the example above, the evaluations may indicate the first sentence has a personality statement for “your attitude and tendency to shift blame.” The evaluations may also indicate that the second sentence has an insult statement for “your offensive and defensive behavior.”

The API module 335 identifies which sentences in the input text include biased language. The API module 335 provides the biased sentences to the text rewrite module 305 and receives one or more candidate replacement texts for each sentence. The API module 335 requests the evaluation module 310 to evaluate the candidate replacement texts for each biased sentence. In one embodiment, for each biased sentence to be rewritten, the text rewrite module 305 selects the candidate replacement text that has an evaluation score equal to or below zero points, that is, replacement texts that have no detected bias based on the set of features for the domain associated with the input text. In another embodiment, the text rewrite module 305 ranks the candidate replacement texts for a sentence and selects the candidate text with the lowest evaluation score.

The API module 335 replaces each biased sentence in the input text with the selected replacement text. The API module 335 provides the revised text as the response to the API request. In one example, the response may be given by:

```
{
  “content”: “In order to improve the situation, it's important to
address any tendencies to shift blame onto others.. It is crucial to
approach conflicts with a more open and understanding mindset,
focusing on finding a resolution rather than placing blame. Your
offensive and defensive behavior during conflict resolution creates a
hostile environment and it's worst to work with.”,
  “changes_made”: true,
  “language”: eng”
}
```

Returning to the document analysis module 130, the feedback module 320 may obtain data from users on the replacement text obtained by the text rewrite module 305. In one instance, as described in further detail below, the feedback is used to construct a training dataset for training or fine-tuning parameters of the LLM to generate improved replacement text based on the feedback. In one instance, the feedback module 320 determines that given a prompt created using the original sentence and other components, a candidate replacement text received positive feedback if the candidate text was selected and replaced the original sentence in the document editor (e.g., by the user clicking the button 460).

In other embodiments, the feedback module 320 may generate one or more UI components (e.g., like or dislike buttons, thumbs up or thumbs down buttons) on the user interface 118 and receive a positive indication of the candidate replacement text if the user (e.g., writer or reader of the document) clicked on the like button or the thumbs up button, or receive a negative indication of the candidate text if the user (e.g., writer or reader of the document) clicked on the dislike button or the thumbs down button. The text that received positive feedback are indicative that the replacement text will help achieve the desired objective of being an unbiased document for a purpose and can be used as training data to further train or fine-tune parameters of the machine-learned model.

The data storage module 320 stores data used by the document analysis module 130. The data include a document corpus 322. The document corpus 322 is a collection of documents that are presented to readers and are associated with a set of known outcomes or feedback.

The corpus management module 325 generates, maintains, and updates the document corpus 322. The corpus management module 325 collects documents in the document corpus 322, as well as their outcomes, from various sources. In one instance, the corpus management module 325 collects documents previously posted and presented to readers and have a set of known outcomes. These documents may include documents posted, and corresponding outcome data received, by the posting server 134. In one embodiment, the corpus management module 325 collects a set of data instances, where a data instance includes previous instances of prompts to request generation of replacement texts for a text unit in the input document, and candidate replacement texts that were generated by the machine-learned model that received positive feedback. Therefore, the set of data instances include multiple pairs of (prompt, positive text), in which the positive text is text determined to have received positive feedback. The training data may be stored in the document corpus store 322.

The training module 330 trains or further fine-tunes parameters of the machine-learned models deployed by the model serving system 145 based on the created training dataset. In one embodiment, the training module 330 obtains the pairs of prompts and positive text in the training dataset. The training module 330 encodes the pair into a set of input tokens, where a token is a numerical vector representing a word, sub-word, phrase in a latent space. When the transformer architecture of the machine-learned model (e.g., LLM) is an autoregressive architecture, the LLM may be applied to generate one or more output tokens that correspond to the positive text. An output token is decoded to determine a probability that the decoded token corresponds to a corresponding token in the positive text.

The training module 330 determines a loss function across the one or more output tokens that indicates a difference (e.g., logit probability distribution difference) between the tokens in the positive text and the output tokens generated by the forward pass of the transformer model. As an example, the loss function may be an NLP loss for each token combined across one or more output tokens generated for the positive text. The training module 330 obtains one or more terms from the loss function and performs backpropagation to update parameters of the transformer architecture. After the model has been trained or fine-tuned, the candidate texts generated using the updated model may be presented to the user and feedback can be again obtained for these candidate replacement texts. The newly obtained feedback may be used to reconstruct the training dataset and the parameters of the machine-learned model may be continuously refined as more feedback is obtained.

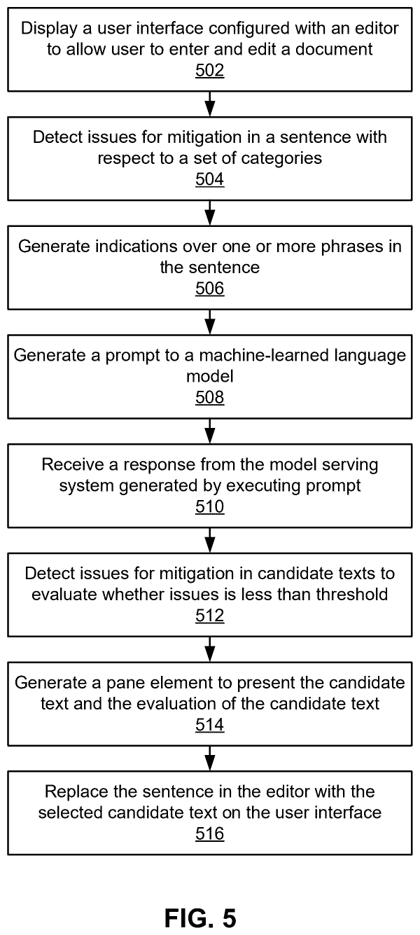

FIG. 5 is a flowchart illustrating a process of rewriting text for an electronic document, according to one embodiment. In one embodiment, the process of FIG. 5 is performed by the analysis server 126. Other entities may perform some or all of the steps of the process in other embodiments. Likewise, embodiments may include different and/or additional steps, or perform the steps in different orders.

The analysis server 126 displays 502 a user interface configured with an editor to allow a user to enter and edit an electronic document. For a sentence of the electronic document, the analysis server 126 detects 504 issues for mitigation in the sentence with respect to a set of categories. The analysis server 126 generates 506 one or more indications over one or more phrases in the sentence. In one embodiment, an indication generated for a phrase is generated based on detection of a respective category associated with the phrase. Responsive to receiving a request from the user to rewrite the sentence, the analysis server 126 generates 508 a prompt to a machine-learned language model. The prompt specifies at least a text of the sentence and a request to generate a set of candidate texts. The analysis server 126 receives 510, from the model serving system, a response generated by executing the machine-learned language model on the prompt. For a candidate text, the analysis server 126 detects 512 issues for mitigation in the candidate text to evaluate whether a degree of the detected issues in the candidate text is less than a predetermined threshold. The analysis server 126 generates 514 a pane user element to present the candidate text and an evaluation of the candidate text to the user. Responsive to receiving a selection of a candidate text, the analysis server 126 replaces 516 the sentence in the editor with the selected text on the user interface in the electronic document.

### OTHER CONSIDERATIONS

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for generating evaluations of documents based on one or more outcomes of the document. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

1. A computer-implemented method, comprising:
displaying a user interface configured with an editor to allow a user to enter and edit an electronic document;
for a sentence of the electronic document, detecting issues for mitigation in the sentence with respect to a set of categories;
generating one or more indications over one or more phrases in the sentence, an indication generated for a phrase generated based on detection of a respective category associated with the phrase;
responsive to receiving a request from the user to rewrite the sentence, generating a prompt to a machine-learned language model, the prompt specifying at least a text of the sentence and a request to generate a set of candidate texts;
receiving, from the model serving system, a response generated by executing the machine-learned language model on the prompt;
for a candidate text, detecting issues for mitigation in the candidate text to evaluate whether a degree of the detected issues in the candidate text is less than a predetermined threshold;
generating a pane user element to present the candidate text and an evaluation of the candidate text to the user; and
responsive to receiving a selection of a candidate text, replacing the sentence in the editor with the selected text on the user interface in the electronic document.

2. The computer-implemented method of claim 1, further comprising:
responsive to user interaction with the indication for the phrase on the user interface, generating an interface element describing the detected category of bias associated with the phrase and an element for the user to request rewriting of the sentence.

3. The computer-implemented method of claim 1, wherein detecting issues for mitigation in the candidate text further comprises:
applying a set of features to the candidate text, wherein a feature corresponds to detection of a respective category of bias, and wherein applying the feature to the candidate text generates an impact score for the category of bias;
generating an evaluation score for the candidate text by combining impact scores across the set of features; and
determining whether the evaluation score is less than the predetermined threshold.

4. The computer-implemented method of claim 1, further comprising:
evaluating each sentence of one or more sentences of the electronic document and storing the evaluations of the one or more sentences in a cache storage;
receiving an indication the user modified an existing sentence or added a new sentence to the input document;
evaluating the modified sentence or the new sentence of the input document;
presenting the evaluation of the modified sentence or the new sentence in the editor; and
retrieving the evaluations of sentences that are unchanged from the cache storage without reevaluating the unchanged sentences.

5. The computer-implemented method of claim 1, further comprising:
providing the prompt to the model serving system via an API call to an endpoint of the model serving system, wherein the API call follows one or a combination of a REST API communication protocol, a RPC protocol, or a gRPC protocol.

6. The computer-implemented method of claim 1, generating the prompt further comprises:
identifying one or more pieces of personal identifiable information (PII) entities in the prompt;
identifying one or more placeholder entities for the one or more PII entities;
generating a modified prompt by replacing the PII entities with respective placeholder entities; and
responsive to receiving the response, replacing the placeholder entities with the respective PII entities in the response.

7. The computer-implemented method of claim 1, further comprising:
receiving an application programming interface (API) request specifying input text, the input text including two or more sentences;
evaluating the input text to detect bias with respect to the set of categories;
identifying one or more biased sentences in the input text based on the evaluations;
obtaining candidate replacement sentences for the biased sentences;
replacing the one or more biased sentences in the input text with a respective candidate replacement text to generate a revised version of the text; and
providing the revised version of the text as a response to the API request.

8. A non-transitory computer-readable storage medium storing executable computer program instructions, the computer program instructions when executed causes one or more processors to:
display a user interface configured with an editor to allow a user to enter and edit an electronic document;
for a sentence of the electronic document, detect issues for mitigation in the sentence with respect to a set of categories;
generate one or more indications over one or more phrases in the sentence, an indication generated for a phrase generated based on detection of a respective category associated with the phrase;
responsive to receiving a request from the user to rewrite the sentence, generate a prompt to a machine-learned language model, the prompt specifying at least a text of the sentence and a request to generate a set of candidate texts;
receive, from the model serving system, a response generated by executing the machine-learned language model on the prompt;
for a candidate text, detect issues for mitigation in the candidate text to evaluate whether a degree of the detected issues in the candidate text is less than a predetermined threshold;
generate a pane user element to present the candidate text and an evaluation of the candidate text to the user; and
responsive to receiving a selection of a candidate text, replace the sentence in the editor with the selected text on the user interface in the electronic document.

9. The non-transitory computer-readable storage medium of claim 8, wherein the computer program instructions when executed further causes the one or more processors to:
responsive to user interaction with the indication for the phrase on the user interface, generate an interface element describing the detected category of bias associated with the phrase and an element for the user to request rewriting of the sentence.

10. The non-transitory computer-readable storage medium of claim 8, wherein the computer program instructions when executed further causes the one or more processors to:
apply a set of features to the candidate text, wherein a feature corresponds to detection of a respective category of bias, and wherein applying the feature to the candidate text generates an impact score for the category of bias;
generate an evaluation score for the candidate text by combining impact scores across the set of features; and
determine whether the evaluation score is less than the predetermined threshold.

11. The non-transitory computer-readable storage medium of claim 8, wherein the computer program instructions when executed further causes the one or more processors to:
evaluate each sentence of one or more sentences of the electronic document and storing the evaluations of the one or more sentences in a cache storage;
receive an indication the user modified an existing sentence or added a new sentence to the input document;
evaluate the modified sentence or the new sentence of the input document;
present the evaluation of the modified sentence or the new sentence in the editor; and
retrieve the evaluations of sentences that are unchanged from the cache storage without reevaluating the unchanged sentences.

12. The non-transitory computer-readable storage medium of claim 8, wherein the computer program instructions when executed further causes the one or more processors to:
provide the prompt to the model serving system via an API call to an endpoint of the model serving system, wherein the API call follows one or a combination of a REST API communication protocol, a RPC protocol, or a gRPC protocol.

13. The non-transitory computer-readable storage medium of claim 8, wherein the computer program instructions when executed further causes the one or more processors to:
identify one or more pieces of personal identifiable information (PII) entities in the prompt;
identify one or more placeholder entities for the one or more PII entities;
generate a modified prompt by replacing the PII entities with respective placeholder entities; and
responsive to receiving the response, replace the placeholder entities with the respective PII entities in the response.

14. The non-transitory computer-readable storage medium of claim 8, wherein the computer program instructions when executed further causes the one or more processors to:
receive an application programming interface (API) request specifying input text, the input text including two or more sentences;
evaluate the input text to detect bias with respect to the set of categories;
identify one or more biased sentences in the input text based on the evaluations;
obtain candidate replacement sentences for the biased sentences;
replace the one or more biased sentences in the input text with a respective candidate replacement text to generate a revised version of the text; and
provide the revised version of the text as a response to the API request.

15. A computer system, comprising:
a processor for executing computer program instructions; and
a non-transitory computer-readable storage medium storing computer program instructions when executed causes one or more processors to:
display a user interface configured with an editor to allow a user to enter and edit an electronic document;
for a sentence of the electronic document, detect issues for mitigation in the sentence with respect to a set of categories;
generate one or more indications over one or more phrases in the sentence, an indication generated for a phrase generated based on detection of a respective category associated with the phrase;
responsive to receiving a request from the user to rewrite the sentence, generate a prompt to a machine-learned language model, the prompt specifying at least a text of the sentence and a request to generate a set of candidate texts;
receive, from the model serving system, a response generated by executing the machine-learned language model on the prompt;
for a candidate text, detect issues for mitigation in the candidate text to evaluate whether a degree of the detected issues in the candidate text is less than a predetermined threshold;
generate a pane user element to present the candidate text and an evaluation of the candidate text to the user; and
responsive to receiving a selection of a candidate text, replace the sentence in the editor with the selected text on the user interface in the electronic document.

16. The computer system of claim 15, wherein the computer program instructions when executed further causes the one or more processors to:
responsive to user interaction with the indication for the phrase on the user interface, generate an interface element describing the detected category of bias associated with the phrase and an element for the user to request rewriting of the sentence.

17. The computer system of claim 15, wherein the computer program instructions when executed further causes the one or more processors to:
apply a set of features to the candidate text, wherein a feature corresponds to detection of a respective category of bias, and wherein applying the feature to the candidate text generates an impact score for the category of bias;
generate an evaluation score for the candidate text by combining impact scores across the set of features; and
determine whether the evaluation score is less than the predetermined threshold.

18. The computer system of claim 15, wherein the computer program instructions when executed further causes the one or more processors to:
evaluate each sentence of one or more sentences of the electronic document and storing the evaluations of the one or more sentences in a cache storage;
receive an indication the user modified an existing sentence or added a new sentence to the input document;
evaluate the modified sentence or the new sentence of the input document;
present the evaluation of the modified sentence or the new sentence in the editor; and
retrieve the evaluations of sentences that are unchanged from the cache storage without reevaluating the unchanged sentences.

19. The computer system of claim 15, wherein the computer program instructions when executed further causes the one or more processors to:
provide the prompt to the model serving system via an API call to an endpoint of the model serving system, wherein the API call follows one or a combination of a REST API communication protocol, a RPC protocol, or a gRPC protocol.

20. The computer system of claim 15, wherein the computer program instructions when executed further causes the one or more processors to:
identify one or more pieces of personal identifiable information (PII) entities in the prompt;
identify one or more placeholder entities for the one or more PII entities;
generate a modified prompt by replacing the PII entities with respective placeholder entities; and
responsive to receiving the response, replace the placeholder entities with the respective PII entities in the response.
